(19) United States
(12) Patent Application Publication
(10) Pub. No.: US 2011/0183596 A1
(43) Pub. Date: Jul. 28, 2011

(54) METHOD AND SYSTEM FOR DEMIST FUNCTION IN A MANUAL CLIMATE CONTROL MODE

(75) Inventors: Dietmar Fischer, Koeln (DE); Stefan Becker, Roesrath (DE); Stefan Wolter, Aachen (DE); Joern Grabke, Koeln (DE); Andreas Ostendorf, Pulheim (DE); Eero Laansoo, Bloomfield Hills, MI (US)

(73) Assignee: FORD GLOBAL TECHNOLOGIES, LLC, Dearborn, MI (US)

(21) Appl. No.: 13/013,223

(22) Filed: Jan. 25, 2011

(30) Foreign Application Priority Data
Jan. 26, 2010 (DE) 10 2010 005 669.3

(51) Int. Cl. B60H 1/26; B60S 1/54; B60S 1/58

(52) U.S. Cl. 454/75; 454/127; 454/124

(57) ABSTRACT

A control device for a climate control system of a motor vehicle has a temperature control for selecting the temperature of the ventilation air supplied by the system. The temperature control is operatively connected with a switch controlling an additional operating function of the climate control system, such that actuation of the temperature control to a demist temperature position actuates the additional operating function to a windshield demist mode. The demist temperature position may advantageously be the full-hot position. The windshield demist mode may include setting an air recirculation function to off, setting an air conditioning function to full cold, setting a blower speed function to maximum output, setting an air distribution function to direct a majority of ventilation air toward a vehicle windshield, and/or setting a rear window heat/defrost function to heat a rear window.

### CROSS-REFERENCE TO RELATED APPLICATIONS

This application claims foreign priority benefits under 35 U.S.C. §119 (a)-(d) to DE 10 2010 005 669.3, filed Jan. 26, 2010, which is hereby incorporated by reference in its entirety.

### BACKGROUND

1. Technical Field

The invention relates to a climate control system of a motor vehicle and to a method and system for manually controlling a climate control system.

2. Background

Motor vehicle climate control systems (also commonly referred to as air conditioning systems) usually comprise a so-called defrost or demist operating function, in which the windshield and/or side windows and possibly the rear windows are freed of mist, moisture and possibly ice, as is necessary in the fall and in winter, for example.

In the case of automatic climate control systems, that is to say those which automatically make the necessary, optimum adjustments, the driver only has to press a corresponding button in order to switch the demist operating function on or off, as necessary.

DE 19621025 A1 discloses a control device for a climate control system of a motor vehicle having at least one control element, which is located in a passenger compartment of the motor vehicle and which is moveably supported in one operating plane for a manual adjustment of an operating function, and comprising a switch arrangement for actuation of an automatic operating function of the climate control system, wherein the control element is additionally supported so that it is axially moveable perpendicularly to the operating plane, and the switch arrangement for actuation of the automatic operating function of the climate control system is operatively connected to the axial mobility of the control element. With this control device the climate control system can be alternately operated automatically or manually.

### SUMMARY

In a disclosed embodiment, a control device for a climate control system of a motor vehicle has a temperature control for selecting the temperature of the ventilation air supplied by the system. The temperature control is operatively connected with a switch controlling an additional operating function of the climate control system, such that actuation of the temperature control to a demist temperature position actuates the additional operating function to a windshield demist mode. The demist temperature position may advantageously be the full-hot position.

In a further disclosed embodiment, the windshield demist mode may include setting an air recirculation function to off, setting an air conditioning function to full cold, setting a blower speed function to maximum output, setting an air distribution function to direct a majority of ventilation air toward a vehicle windshield, and/or setting a rear window heat/defrost function to heat a rear window.

In a further disclosed embodiment, apparatus for controlling a climate control system of a motor vehicle comprises a temperature control actuatable by a vehicle occupant to adjust a temperature of air supplied by the system. When the temperature control is moved to a full-hot position, it activates an additional operating function of the climate control system to select a windshield demist mode. Preferably, the demist mode activates functions including the air recirculation function, the air conditioning function, the blower speed function, the air distribution function, and the rear window defrost function, setting all of these to settings that are appropriate for most efficient windshield demisting

### BRIEF DESCRIPTION OF DRAWING

### Brief Description of the Drawings

Embodiments of the present invention will now be described by way of example only with reference to the accompanying drawing in which:

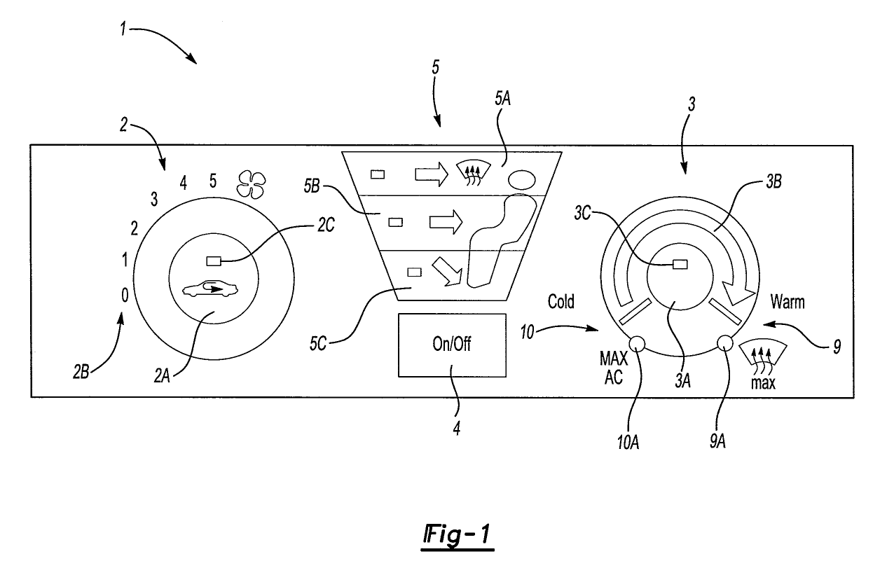

FIG. 1 is a simplified, schematic front view of a control device for a manual climate control system of an automotive vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Referring to FIG. 1, a control device 1 comprises a blower control element 2 which, in the disclosed embodiment, is a rotary knob 2A with a circumferential scale 2B. The rotary knob 2A may also function as a pushbutton in order, for example, to switch the air recirculation function of the climate control system on and off. The rotary knob 2A may therefore also be provided with a corresponding symbol and/or an LED 2C indicating the air recirculation operating mode.

The control device 1 further comprises a temperature control 3 which, in the disclosed embodiment, is a central rotary knob 3A with a circumferential scale 3B. Scale 3B may begin at approximately the 8 o'clock position and may end at approximately the 4 o'clock position, these two positions allowing selection of the lowest (“full-cold”) and highest (“full-hot”) temperature settings respectively. The temperature variation may be indicated by the progressive transition or change in the color of the scale 3B, for example from blue to red.

The rotary knob 3A is supported for movement (i.e., rotation) in one operating plane (i.e., parallel with the front surface of the control device 1) for manual adjustment of the air temperature. Knob 3A may also function as a pushbutton in order, for example, to switch an air conditioning (refrigeration) system on and off. The rotary knob 3A may therefore also be provided with a corresponding symbol and/or an LED 3C that, when illuminated, indicates that the “A/C” or air conditioning mode is activated.

A master climate control system On/Off switch 4 and a switch panel 5 for controlling the air distribution may be located between the rotary knobs 2A and 3A. The individual pushbutton switches of the panel 5A (for directing the air towards the windshield), 5B (for directing air towards the occupants) and 5C (for directing air towards the feet) may likewise be provided with corresponding LEDs for displaying the current operating state.

One extreme of the movement of rotary knob 3A (the 4 o'clock position, for example) selects the highest temperature of air (the full-hot position). The other extreme of movement (the 8 o'clock position, for example) selects the lowest temperature of air (the full-cold position).

The full-hot position of rotary knob 3A also constitutes a demist mode position 9 in which one or more additional operating functions of the climate control system are actuated to contribute to windshield demisting. The term “additional operation functions” refers to any operating mode or function of the climate control system that may be controlled by a vehicle occupant. An LED 9A may be provided which is illuminated when the knob 3A is in the demist mode position 9 and the additional operating functions are actuated.

The demist node position 9 may coincide with any desired demisting temperature, but this most logically coincides with the full-hot position since hot air is most effective in demisting.

When the rotary knob 3A is placed to the demist mode position 9, in addition to selecting the desired demisting temperature (full-hot, in this example) the following operating functions of the climate control system settings may also instituted or activated to achieve most effective and quickest demisting: The air recirculation operating function is switched off (which may be indicated from the LED 2C being not illuminated), thus providing fresh, outside air which is usually drier (less humid) than recirculated interior air; the air conditioning/cooling system operating function is switched on, thus providing maximum dehumidification of the air; the rear window defrost/heat operating function is switched on; the blower operating function is set to maximum output; and the air distribution operating function is controlled via suitable means (switches, valves, louvers, etc.) to direct all or a majority of the heated and/or dehumidified ventilation air at the windshield, which may be indicated by the corresponding LED of the pushbutton 5A.

The temperature control may advantageously be a rotary knob, since this has only a small fitting depth. However, the temperature control may also be embodied as a function selector lever having a range of motion other than the rotary motion of knob 3A.

The full-cold position of knob 3A may also constitute a maximum air conditioning position 10, with an LED 10A be provided to indicate that operating state.

The temperature control is operatively connected to other functions of the switch arrangement controlling the climate control system in such a way that the demist mode can be triggered my making a single control actuation, that being moving the temperature control to a temperature setting that coincides with a demist mode, and selection of the demist mode simultaneously activates other functions of the climate control system that are appropriate for windshield demisting.

In this way, operating errors due to incorrect selection of the demisting air temperature are prevented. It is also thus possible to dispense with separate control elements, such as pushbuttons, that would otherwise have to be actuated by the operator to optimize the CCS for the demist mode. Thus, the control system is easier and quicker to use, as well as less expensive to manufacture.

In other words, the upper end of the temperature setting path (the full-hot position) serves as a switch position that switches on the demist mode and at the same time sets or maintains the full-hot temperature setting, which is the most effective temperature when the demist mode is desired.

In addition to selection of the highest temperature setting, at least one other operating function of the climate control system is selected or adjusted to a setting or mode that contributes to effective demisting of the windshield.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A climate control system of a motor vehicle comprising:
a control device having a temperature control for selecting an air temperature supplied by the system, the temperature control operatively connected with a switch controlling an additional operating function of the climate control system such that actuation of the temperature control to a demist temperature position actuates the additional operating function to a windshield demist mode.

2. The apparatus of claim 1, wherein the demist temperature position is a full-hot position.

3. The apparatus of claim 1, wherein the temperature control is moveably supported in one operating plane.

4. The apparatus of claim 1, wherein the additional operating function is a air recirculation operating function, and actuation of temperature control to the demist temperature position turns air recirculation off.

5. The apparatus of claim 1, wherein the additional operating function is an air conditioning operating function, and actuation of the temperature control to the demist temperature position turns an air conditioner system on.

6. The apparatus of claim 1, wherein the additional operating function is an air blower operating function, and actuation of the temperature control to the demist temperature position turns an air blower to maximum output.

7. The apparatus of claim 1, wherein the additional operating function is an air distribution operating function, and actuation of the temperature control to the demist temperature position directs the ventilation toward a windshield.

8. The apparatus of claim 1, wherein the additional operating function is a rear window heat operating function, and actuation of the temperature control to the demist temperature position applies heat to a rear window.

9. The apparatus of claim 1, wherein the temperature control is a rotary knob.

10. Apparatus for controlling a climate control system of a motor vehicle comprising:
a temperature control actuatable by a vehicle occupant to adjust a temperature of air supplied by the system, the temperature control movable to a full-hot position wherein it activates an additional operating function of the climate control system to select a windshield demist mode.

11. Apparatus according to claim 10 wherein the additional operating function comprises at least one of an air recirculation function, an air conditioning function, a blower speed function, an air distribution function, and a rear window defrost function.

12. Apparatus according to claim 10 wherein the demist mode comprises:
setting an air recirculation function to off;
setting an air conditioning function to maximum cooling;
setting a blower speed function to maximum output; and
setting an air distribution function to direct a majority of ventilation air toward a windshield of the vehicle.

13. The apparatus of claim 10, wherein the temperature control is a rotary knob.
